(19) United States
(12) Patent Application Publication
(10) Pub. No.: US 2025/0200717 A1
(43) Pub. Date: Jun. 19, 2025

(54) AI Face Replacement Device

(71) Applicant: Morphusai Co., Ltd., Taipei City (TW)

(72) Inventors: Chia-Chun HSIEH, Taichung City (TW); Wei-Xiang NI, New Taipei City (TW)

(21) Appl. No.: 18/803,097

(22) Filed: Aug. 13, 2024

(30) Foreign Application Priority Data
Dec. 19, 2023 (TW) 112149487

(51) Int. Cl. G06T 5/60; G06T 5/77; G06T 13/40; G06T 15/50; G06V 10/774; G06V 10/82; G06V 40/16

(52) U.S. Cl. CPC G06T 5/60; G06T 5/77; G06T 13/40; G06T 15/506; G06V 10/82; G06V 40/162; G06V 40/171; G06T 2207/20081; G06T 2207/20084; G06T 2207/30201; G06V 10/774

(57) ABSTRACT

The present invention proposes an AI face replacement device by artificial intelligence face replacement model and post-production adjustments, which includes a face replacement module for performing high-quality face replacement, a light and shadow capture and application module, configured to capture the light and shadow of the face of the replaced object, the face light and shadow are pasted back to the face that has completed the face replacement, a post-production adjustment module configured to provide parameter adjustments and corrections of the face replacement, and an output module configured to output the processed image in a required format.

### CROSS-REFERENCE TO RELATED APPLICATIONS

The present application is based on, and claims priority from TAIWAN patent application serial numbered 112149487, filed on Dec. 19, 2023, the disclosure of which is hereby incorporated by reference in its entirety.

### TECHNICAL FIELD

The present invention relates to a face swapping technology, and more particularly, an artificial intelligence (AI) face replacement device.

### BACKGROUND

With the development of artificial intelligence (AI) technology, face replacement technology has been widely used in many fields. Especially in the film and television industry, high-quality face swapping effects can greatly improve production efficiency and image quality. One of the application scenarios of AI face swapping technology is to replace the face of a virtual character with the facial area of a real person in movies and TV series, and the replacement result usually requires natural facial expressions and realistic effects. However, relying solely on AI models may not achieve required results, and manual intervention and adjustments may be required in specific situations.

During the implementation of traditional face swapping technology, splicing defects will occur. For example, the interpupillary distance and the angles of the inner and side corners of the eyes in the original image are different, and the light and shadow on the face of the replaced object are inconsistent, making the model's face after replacement appeared to have problems, such as excessive interpupillary distance and eyes tilted upward, and looked distorted. Since the face of the entire video needs to be replaced in the later stage, the phenomenon of splicing defects needs to be optimized in the early stage. Current optimization method is to adjust the original picture, and the workload is enormous for the modification of the original picture in the video, making modification less efficient.

In addition, conventional face swapping technology, such as Deepface Lab's deepfake technology, usually requires multiple videos of the same target object for training model and then performing face replacement. However, this method is time-consuming and impractical. The present invention aims to solve these problems and provide a technology that can perform face replacement with only a clear face photo of the target object.

### SUMMARY

The purpose of the present invention is to provide an artificial intelligence (AI) face replacement device, which includes a processor; a storage device couple to the processor; a face swapping module, stored in the storage device and accessible through the processor, configured to perform face replacement between a source face image and a target face image, wherein the target face image is replaced by the source face image; a light and shadow capture and application module, stored in the storage device and accessible through the processor, configured to capture light and shadow of the target face and to paste back the light and shadow on a replaced face image that has completed the face replacement; an adjustment module, stored in the storage device and accessible through the processor, configured to provide parameter adjustments and corrections of the replaced face image; and an output module, stored in the storage device and accessible through the processor, configured to output processed image of the replaced face image in a required format.

In one preferred embodiment, the AI face replacement device further comprises: an image input module, stored in the storage device, configured to receive image or video data of a target subject; and a data collection module, stored in the storage device and accessible through the processor, configured to collect and prepare facial image data outputted from the image input module.

In one preferred embodiment, the face swapping module at least includes a convolutional neural network (CNN), a generative adversarial network (GAN), an optical mask segmentation unit and a feature extraction unit.

In one preferred embodiment, the convolutional neural network (CNN) is used to extract important facial features from the inputted image data, the generative adversarial network (GAN) is used to generate facial image from the inputted image data with natural and high quality and the optical mask segmentation unit is used to accurately identify and separate facial areas.

In one preferred embodiment, the face swapping module further includes a blind face restoration unit to inpaint the generated facial image and further optimize the face replacement.

In one preferred embodiment, the face swapping module further includes a detailed expression capture and animation (DECA) model and a faces learned with an articulated model and expression (FLAME) model used to perform face replacement at different angles.

In one preferred embodiment, the DECA model is capable of reconstructing a 3D head model with detailed facial geometry based on a single input image, and the generated 3D head model is easily used to produce animation.

In one preferred embodiment, the FLAME model learned from four-dimensional (4D) data, i.e. three-dimensional (3D) data sequence, which can provide dynamic facial generation and achieve accuracy and authenticity of high-end models.

In one preferred embodiment, the adjustment module is configured to restore eyes and teeth of the replaced face image to greatest extent.

In one preferred embodiment, the processor includes a multi-core central processing unit (CPU), a graphics processor unit (GPU), a digital signal processor (DSP), an application specific integrated circuit (ASIC), or their combinations.

In one preferred embodiment, the AI face replacement device configured to realize film and television image restoration process includes executing the following steps through the processor:

performing training on the face swapping module by utilizing a large amount of publicly available photos or videos as training material, through multiple iterations of training process, to enable the face swapping module to effectively learn and simulate various facial features and expressions;

inputting target image data including the source face image and the target face video; performing preliminary processing on the target image data by the face swapping module that has been trained for automated face recognition, feature extraction, and image synthesis to achieve face swapping between the face of the source face image and the target face video and outputting the replaced face image;

making detailed adjustments to the replaced face image outputted from the face swapping module by the adjustment module with professional post-production; and

outputting the final restored or optimized image or video clips by the output module after performing the professional post-production.

In one preferred embodiment, the detailed adjustments includes correcting edges, adjusting light and shadow, and optimizing color balance on the outputted results of the face swapping module.

In one preferred embodiment, the AI face replacement device, further includes executing the following steps through said processor:

restoring and inpainting the replaced face image generated by the face swapping module that has been trained by using face enhance and blind face restoration technology; and

capturing light and shadow of the target face and pasting the light and shadow back on the replaced face image by light and shadow capture and application module.

In one preferred embodiment, the step of restoring face image generated by the face swapping module that has been trained includes restoring specific structures, comprising teeth, eyes, skin, skeleton, or their combinations.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a functional block diagram of an AI face replacement device according to an embodiment of the present invention.

FIG. 2A shows the implementation process of the AI face replacement device according to an embodiment of the present invention.

FIG. 2B shows the execution steps of the AI face replacement device according to an embodiment of the present invention.

FIG. 3 shows an example of applying the AI face replacement device of the present invention to perform face replacement.

FIG. 4 shows a functional block diagram of an exemplary computer system/server for implementing embodiments of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides an AI face replacement device and related method, which utilizes face swapping model and post-stage adjustments to restore or optimize film and television images. The AI face replacement device first uses an advanced AI face swapping model to perform automatic image processing, and then makes adjustments through a computer to improve and optimize the image.

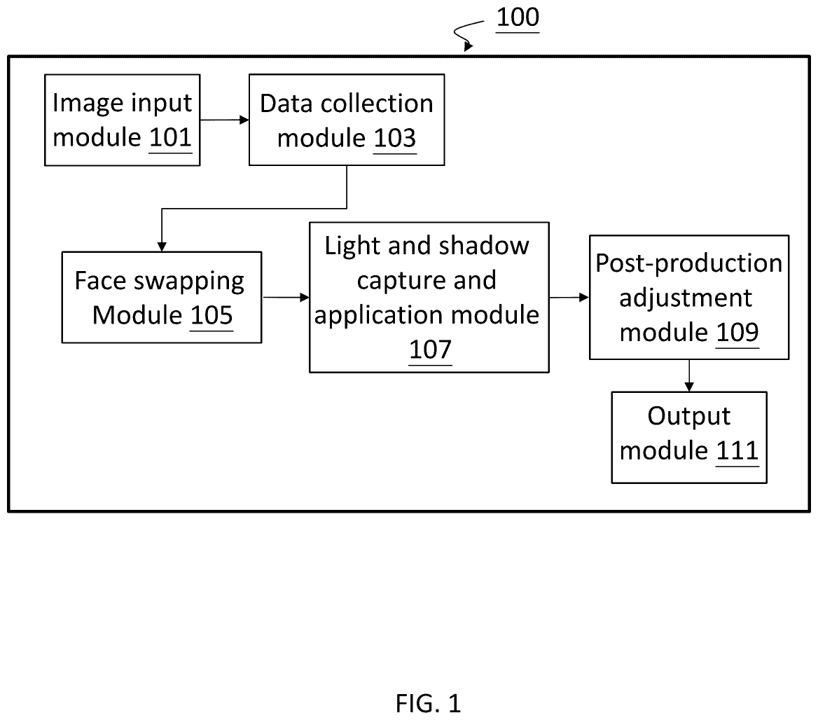

The AI face replacement device 100 proposed by the present invention, with reference to FIG. 1, mainly includes: an image input module 101, which is responsible for receiving and processing images or video data provided by the user, the image input module 101 can support image/video data in various formats and sources; a data collection module 103 is responsible for collecting and preparing the required facial image data that outputted from the image input module 101; a face swapping module 105 includes convolutional neural networks (CNN), generative adversarial networks (GAN), an optical mask segmentation unit, a blind face restoration unit and a feature extraction unit for performing high-quality face replacement; a light and shadow capture and application module 107 is used to capture the light and shadow of the face of the object to be replaced, and then paste the light and shadow back to the face that has completed the face replacement; after the face replacement and blind face restoration, to enhance the reality, an adjustment module 109 allows the electronic computing device, such as computer, to adjust parameters and correct the replacement results in the later stage to achieve the best image effect, which includes restoring the eyes and teeth to the greatest extent and performing other manual corrections to ensure that the generated image has a high degree of reality and naturalness; and an output module 111 is responsible for outputting the processed images in the required format and preparing them for delivering to customers or for subsequent film and television production. All the aforementioned modules and units can be represented in program codes and are stored in the storage device 424, can be calculated and accessed through the processor 414.

According to some embodiments of the present invention, the aforementioned face swapping module 105 mainly includes a convolutional neural network (CNN), a generative adversarial network (GAN), an optical mask segmentation unit, a blind face restoration. unit and a feature extraction unit. Among them, the convolutional neural network (CNN) is responsible for extracting important facial features from the input image, the generative adversarial network (GAN) is responsible for generating natural and high-quality facial images, and the optical mask segmentation unit is responsible for accurately identifying and separating facial areas. In addition, the blind facial restoration unit provides blind facial restoration technology to restore the generated facial image and further optimize the facial replacement effect through feature extraction performed by the feature extraction unit.

According to an embodiment of the present invention, the face swapping module 105 includes Faceswap, Simswap or other similar AI video face swapping software.

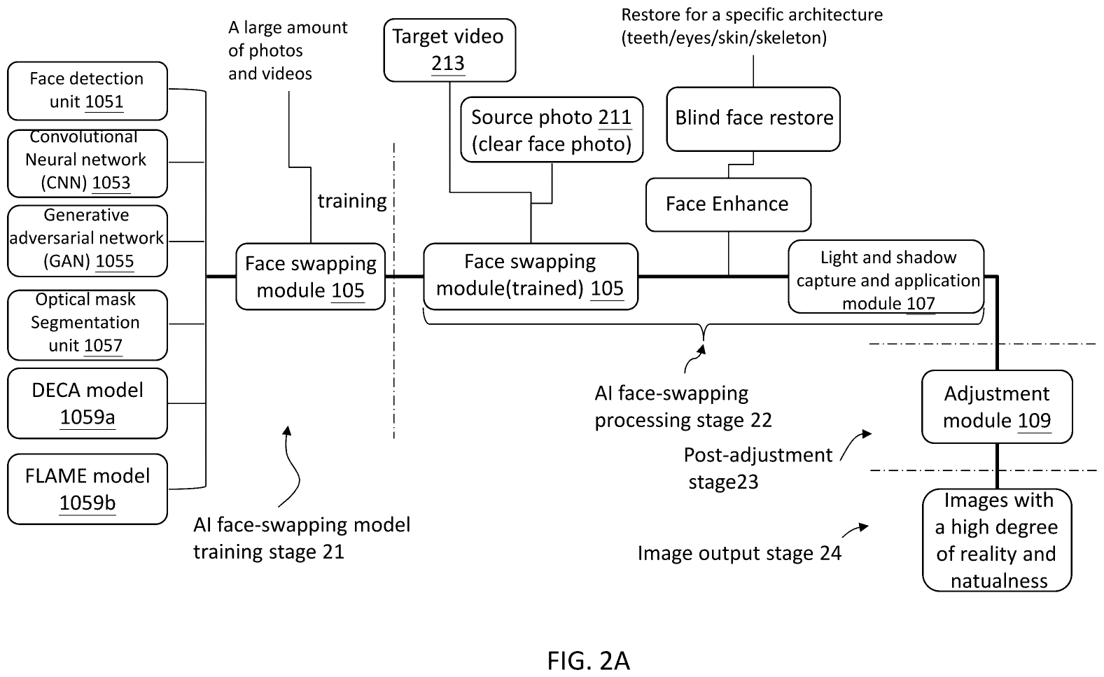

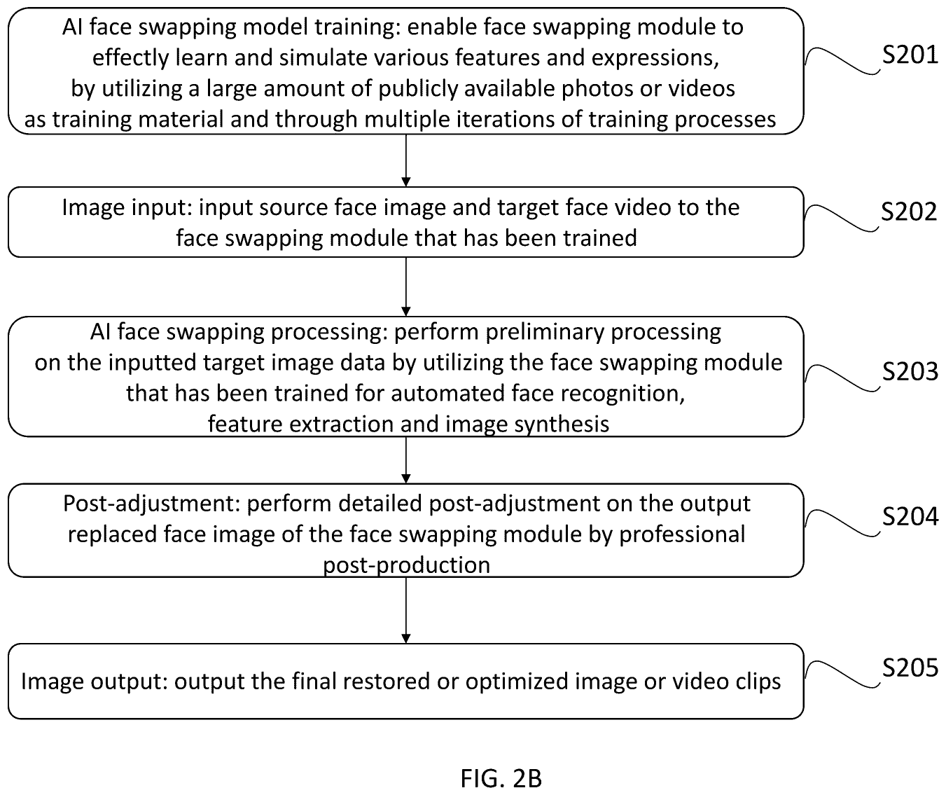

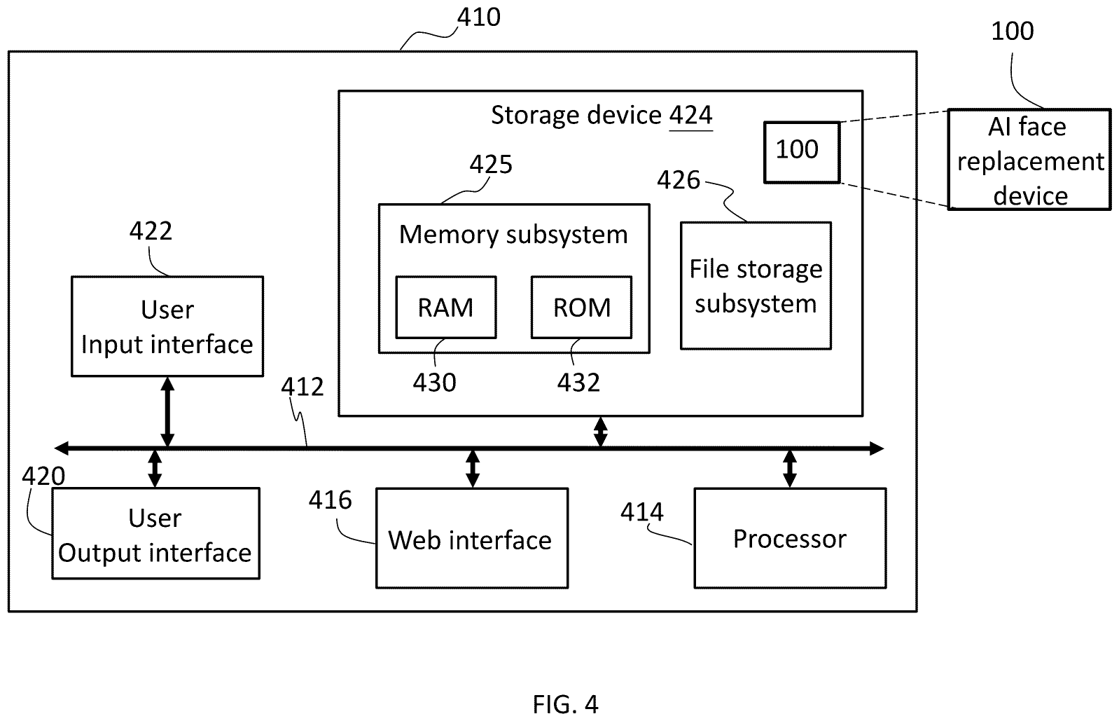

FIG. 2A shows the implementation process of the present invention using AI face swapping model and post-adjustment to achieve image restoration of film and television. First, the AI face swapping model is trained (AI face swapping model training stage 21). In this model training phase, a large amount of publicly available photos and videos are used as training material to train the face swapping module 105. The face swapping module 105 can effectively learn and simulate different facial features and expressions through multiple iterations of the training process. In the AI face-swapping processing stage 22, the source photo (clear face photo) 211 and the target video 213 are imported into the face swapping module 105 that has been trained, and the input source image is preliminarily processed for automated face recognition, feature extraction and image synthesis to achieve high-quality face replacement, that is, face swapping is accomplished between the faces in the source photo and the target video; next, the facial image generated by the trained face swapping module 105 is inpainted and restored by utilizing the face enhancement and blind face restoration technologies, especially for specific architectures, such as teeth/eyes/skin/skeleton; then, the light and shadow of the replaced object's face (i.e. target object's face) are captured through the light and shadow capture and application module 107, and after performing the aforementioned face replacement and blind face restoration steps, the captured light and shadow are pasted back to the replaced face to increase realism. In the post-adjustment stage 23, a professional post-production is used to perform detailed adjustments on the output results of the face swapping module, through the adjustment module 109, including improvement of imaging accuracy and noise remove. At last, in the image output stage 24, the restored and optimized image or video clips are outputted. Each of the aforementioned processes and steps can be calculated and accessed through the processor 414 (see FIG. 4), and the temporary results or final results after processing can be stored in the storage device 424 (see FIG. 4); the aforementioned modules and units can be represented in program codes and are all stored in the storage device 424 (see FIG. 4) and can be accessed through the processor 414 to perform operations.

According to an embodiment of the present invention, the aforementioned face enhancement technology includes, for example, Codeformer, GFPGAN and other algorithms for face restoration technology.

According to some embodiments of the present invention, in the AI face-swapping model training stage 21, a large number of input public photos and videos are processed through the face detection unit 1051 provided in the face swapping module 105 for face detection, the convolutional neural network (CNN) 1053 is used to extract important facial features from input photos and images, the generative adversarial network (GAN) 1055 is responsible for generating natural and high-quality facial images, the optical mask segmentation unit 1057 is used to perform face data crawling and subsequently the DECA model 1059a and the FLAME model 1059b are used to perform face replacement at different angles. The DECA model 1059a, which stands for Detailed Expression Capture and Animation model, can reconstruct a 3D head model with detailed facial geometry based on a single input image, and the generated 3D head model can be easily used to produce animation. FLAME model 1059b, which stands for Faces Learned with an Articulated Model and Expression, is a model learned from four-dimensional (4D) data (three-dimensional (3D) data sequence), which can provide dynamic facial generation and achieve the accuracy and authenticity of high-end models. Each of the aforementioned processes and steps can be calculated and accessed through the processor 414 (see FIG. 4), and the temporary results or final results after processing can be stored in the storage device 424 (see FIG. 4); the aforementioned modules and units can be represented in program codes and are all stored in the storage device 424 (see FIG. 4) and can be accessed through the processor 414 to perform operations.

FIG. 2B shows an embodiment of the AI face replacement device 100 of the present invention. The implementation process for realizing film and television image restoration includes executing the following steps through the processor 414 (refer to FIG. 4): first, step S201, AI face-swapping model training stage: the face swapping module can effectively learn and simulate different facial features and expressions by using a large number of public photos and video data as training data and through multiple iterative training processes; step S202, image input step: input target images, including source photos and target videos, to the face swapping module 105 that has completed training (refer to FIG. 1); step S203, AI face-swapping processing step: perform preliminary processing on the aforementioned input target image for automated face recognition, feature extraction and image synthesis by using the face swapping module 105 (refer to FIG. 1) that has been trained to achieve high quality face replacement (that is, swapping the face of the source photo with the target video), this step further includes inpainting and restoring the replaced facial image generated by the face swapping module 105 that has trained by using facial enhancement and blind facial restoration technologies, especially for specific architectures, such as teeth/eyes/skin/skeleton, capturing the light and shadow of the object's face to be replaced through the light and shadow capture and application module 107, and pasting the light and shadow back to the replaced face image to increase the realism of the replaced face; step S203, post-adjustment step: perform detailed post-adjustment on the output results of the face swapping module 105, including correcting edges, adjusting light and shadow, optimizing color balance, etc. by using professional post-production; step S204, image output step: output the final restored or optimized image or video clips. Each of the aforementioned processes and steps can be calculated and accessed through the processor 414 (see FIG. 4), and the temporary results or final results after processing can be stored in the storage device 424 (see FIG. 4); the aforementioned modules and units can be represented in program codes and are all stored in the storage device 424 (see FIG. 4) and can be accessed through the processor 414 to perform operations.

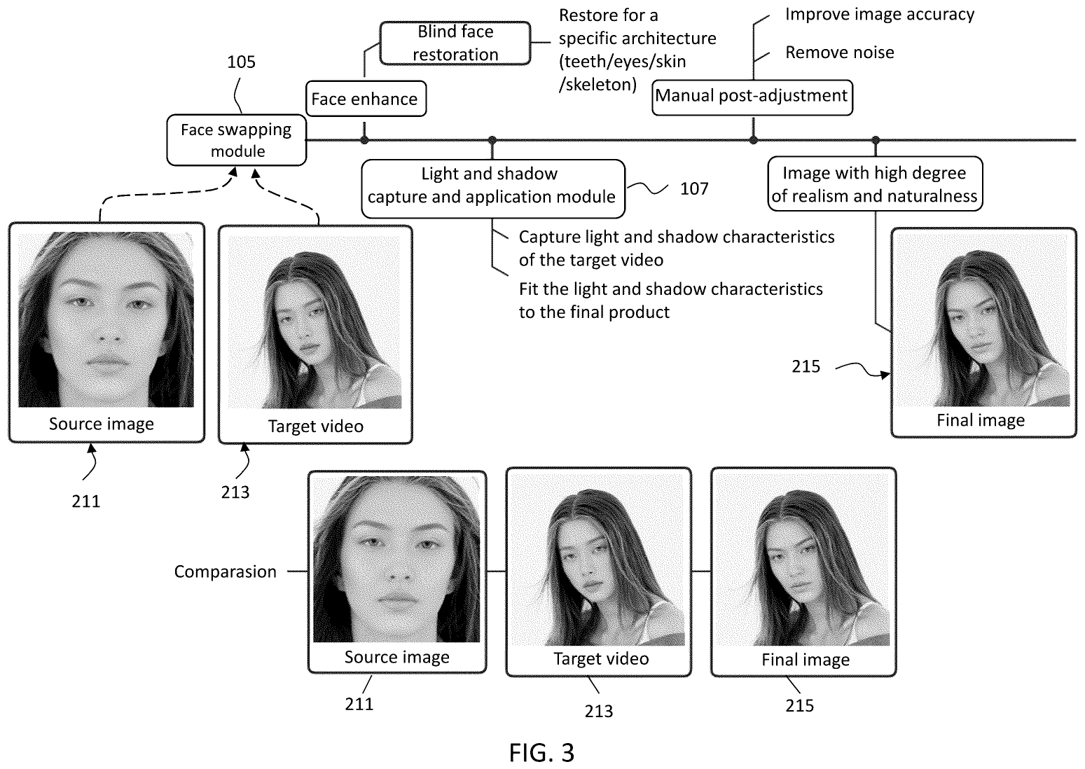

FIG. 3 is an embodiment of applying the AI face replacement device 100 of the present invention to perform face replacement. In this embodiment, the actual output final image 215 after face replacement is highly realistic and natural, the face replacement is performed by inputting the source photo 211 and the target video 213 to the face swapping module 105 that has been trained.

Compared with conventional face-swapping technology, such as Faceswap technology based on Deepface Lab, the film and television image restoration technology provided by the present invention has higher efficiency and accuracy. High-quality face replacement can be achieved with just one single clear source photo of the target face, and further adjustments can be made to optimize the results. In addition, the face swapping model proposed by the present invention can accurately identify and repair facial areas through optical mask segmentation and blind face restoration technology, thereby ensuring that the generated facial image has a high degree of realism and naturalness.

Compared with conventional face-swapping models (for example, Faceswap technology), the AI face replacement device proposed by the present invention can provide a variety of adjustable parameters and configuration options to meet different application needs and standards. Post-production personnel can adjust and optimize the parameters of the face swapping model proposed in the present invention according to actual needs to achieve the best replacement effect. In addition, post-production personnel can quickly and easily complete image synthesis and modification by providing a complete and automated technical process, thus greatly improving film and television production efficiency and image quality.

The following paragraphs provide specific embodiments:

### Implementation 1: Hollywood Stand-In

In Hollywood film production, this technology can be used to quickly replace the protagonist's face with a stuntman, and through post-production adjustments, natural and high-quality image effects can be achieved, therefore greatly reducing production costs and time. Specific steps are listed as follows:
(1). Data collection: Collect facial data of target actors from public photos and videos. Since this technique only requires one single clear photo of the target actor's face, the data collection process is relatively simple and efficient.
(2). Model training and face replacement: Use the AI face swapping model to replace the target actor's face into specific movie clips. High-quality face replacement can be completed using one single photo, which will reduce data requirements and computing costs.
(3). Parameter adjustment and manual correction: Ensure a high-quality and realistic replacement effect through parameter adjustment and correction by post-production personnel, including the adjustment of light and shadow, as well as the restoration of eyes and teeth to the greatest extent.

### Implementation 2: Virtual Idol

In the training and maintenance of virtual idols, this technology can be used to generate high-quality face images, and the images can be optimized and improved through post-production adjustments enabling that the virtual idols are more visually realistic and eye-catching. Specific steps are as follows:
(1). Data collection: Collect a large number of facial photos and videos from the Internet for training the model. Because this technology only requires one single clear photo of the target's face, the data collection process is simpler.
(2). Model training and face replacement: Use the AI face-swapping model to create a virtual idol's face model and present it when needed. The need for only one single photo greatly simplifies the replacement process and reduces computational and storage requirements.
(3). Parameter adjustment and correction: Ensure a high-quality and realistic replacement effect through post-stage parameter adjustment and correction, including the adjustment of light and shadow, as well as the restoration of eyes and teeth to the greatest extent.

The above methods or embodiments proposed by the present invention can be executed in a server or similar computer system. For example, the calculation, calculation program and the AI face replacement device 100 shown in FIGS. 1-3 can be executed through the processor 414 to process the required information and can be stored in the storage device 424. The AI face replacement device 100 proposed by the present invention (refer to FIG. 1), which exists in a server or similar computer system 410 as shown in FIG. 4. Functional block diagram of the server or similar computer system 410 is illustrated in FIG. 4. It should be emphasized that the server/computer system shown in FIG. 4 is only used as an example and should not impose any limitations on the embodiments and scope of usages of the present invention.

As shown in FIG. 4, the server/computer system 410 is in the form of a general computing device. Server/computer system 410 typically includes at least one processor 414 that is communicatively connected to a plurality of peripheral devices through bus subsystem 412. These peripheral devices may include storage devices (e.g., memory subsystem 425 and file storage subsystem 426) 424, user output interface 420, user input interface 422, and network interface subsystem 416. The network interface subsystem 416 provides a connection interface to the external network and is coupled to corresponding interface devices of other computing devices.

According to embodiments of the present invention, the processor 414 may include a multi-core central processing unit (CPU), a graphics processor unit (GPU), a digital signal processor (DSP), an application specific integrated circuit (ASIC), or their combinations, etc.

User input interface 422 may interface with input devices including keyboard, pointing device such as mice, trackball, trackpad or graphics tablet, scanner, touch screen integrated into display, voice input device such as speech recognition system, microphone, and other types of input devices, etc.

User output interface 420 may interface with output devices including a display subsystem, a printer, a fax machine, or a non-visual display such as a sound output device. The display subsystem may include a cathode ray tube display (CRT), a flat panel device such as a liquid crystal display (LCD), a projection device, or other mechanism for producing visual images. The display subsystem may also provide non-visual displays by sound output devices.

Storage device 424 stores programming and data constructs that provide functionality for some or all modules described in the present invention. For example, a program or program module stored in the storage device may be configured to perform the functions of various embodiments of the invention. The aforementioned programs or program modules may be executed by the processor alone or in combination with other processors.

The memory subsystem 425 in the storage device 424 can include a plurality of memories, including a main random access memory (RAM) 430 for storing instructions and data during program execution, and a read-only storage memory (ROM) 432 for storing fixed instructions. File storage subsystem 426 provides persistent storage for program and data files and may include hard drives, optical drives, or removable media cartridges. Functional modules for implementing certain embodiments may be stored in storage device 424 via file storage subsystem 426, or in other machines that can be retrieved/accessed by one or more processors.

The bus subsystem 412 provides a mechanism so that various components and subsystems of the computing device/device can communicate with each other in an expected manner. Although bus subsystem 412 is illustratively presented as a single bus, alternative implementations of bus subsystem 412 may use multiple buses.

Computing device may be of various types, including workstation, server, computing cluster, or other data processing system or computing device.

The technology of the present invention can be widely used in a variety of fields such as film production, advertising production, and virtual idol creation. By providing a complete and automated technical process, the present invention can not only significantly reduce the cost and time of film and television production, but also provide higher quality and more natural visual effects of film and television, thereby enhancing the audience's visual experience.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. An artificial intelligence (AI) face replacement device, comprising:
a processor;
a storage device couple to said processor;
a face swapping module, stored in said storage device and accessible through said processor, configured to perform face replacement between a source face image and a target face image, wherein said target face image is replaced by said source face image;
a light and shadow capture and application module, stored in said storage device and accessible through said processor, configured to capture light and shadow of said target face and to paste back said light and shadow on a replaced face image that has completed said face replacement;
an adjustment module, stored in said storage device and accessible through said processor, configured to provide parameter adjustments and corrections of said replaced face image; and
an output module, stored in said storage device and accessible through said processor, configured to output processed image of said replaced face image in a required format.

2. The AI face replacement device of claim 1, further comprising:
an image input module, stored in said storage device, configured to receive image or video data of a target subject; and
a data collection module, stored in said storage device and accessible through said processor, configured to collect and prepare needed facial image data outputted from said image input module.

3. The AI face replacement device of claim 2, wherein said face swapping module at least includes a convolutional neural network (CNN), a generative adversarial network (GAN), an optical mask segmentation unit and a feature extraction unit.

4. The AI face replacement device of claim 3, wherein said convolutional neural network (CNN) is used to extract important facial features from said inputted image data, said generative adversarial network (GAN) is used to generate facial image from said inputted image data with natural and high quality and said optical mask segmentation unit is used to accurately identify and separate facial areas.

5. The AI face replacement device of claim 4, wherein said face swapping module further includes a blind face restoration unit to inpaint said generated facial image and further optimize said face replacement.

6. The AI face replacement device of claim 4, wherein said face swapping module further includes a detailed expression capture and animation (DECA) model and a faces learned with an articulated model and expression (FLAME) model used to perform face replacement at different angles.

7. The AI face replacement device of claim 6, wherein said DECA model is capable of reconstructing a 3D head model with detailed facial geometry based on a single input image, and said generated 3D head model is easily used to produce animation.

8. The AI face replacement device of claim 6, wherein said FLAME model learned from four-dimensional (4D) data, i.e. three-dimensional (3D) data sequence, which can provide dynamic facial generation and achieve accuracy and authenticity of high-end models.

9. The AI face replacement device of claim 1, wherein said adjustment module is configured to restore eyes and teeth of said replaced face image to greatest extent.

10. The AI face replacement device of claim 1, wherein said processor includes a multi-core central processing unit (CPU), a graphics processor unit (GPU), a digital signal processor (DSP), an application specific integrated circuit (ASIC), or their combinations.

11. The AI face replacement device of claim 2, wherein said AI face replacement device configured to realize film and television image restoration process includes executing the following steps through said processor:
performing training on said face swapping module by utilizing a large amount of publicly available photos or videos as training material, through multiple iterations of training process, to enable said face swapping module to effectively learn and simulate various facial features and expressions;
inputting target image data including said source face image and said target face video;
performing preliminary processing on said target image data by said face swapping module that has been trained for automated face recognition, feature extraction, and image synthesis to achieve face swapping between said source face image and said target face video and outputting said replaced face image;
making detailed adjustments to said replaced face image outputted from said face swapping module by said adjustment module with professional post-production; and
outputting said final restored or optimized image or video clips by said output module after performing said professional post-production.

12. The AI face replacement device of claim 11, wherein said detailed adjustments includes correcting edges, adjusting light and shadow, and optimizing color balance on said outputted results of said face swapping module.

13. The AI face replacement device of claim 11, wherein said preliminary processing further includes executing the following steps through said processor:
restoring and inpainting face image generated by said face swapping module that has been trained by using face enhance and blind face restoration technology; and
capturing light and shadow of said target face and pasting said light and shadow back on said replaced face image by light and shadow capture and application module.

14. The AI face replacement device of claim 13, wherein said step of restoring face image generated by said face swapping module that has been trained includes restoring specific structures, comprising teeth, eyes, skin, skeleton, or their combinations.
